(19) United States
(12) Patent Application Publication
(10) Pub. No.: US 2016/0202454 A1
(43) Pub. Date: Jul. 14, 2016

(54) CAMERA LENS

(71) Applicant: HON HAI PRECISION INDUSTRY CO., LTD., New Taipei (KR)

(72) Inventor: TSUNG-HENG CHANG, New Taipei (TW)

(21) Appl. No.: 14/736,956

(22) Filed: Jun. 11, 2015

(30) Foreign Application Priority Data
Jan. 12, 2015 (TW) 104101007

(51) Int. Cl. G02B 13/00; H04N 5/225; G02B 9/60

(52) U.S. Cl. CPC G02B 13/0015; G02B 9/60; H04N 5/2254

(57) ABSTRACT

A camera lens includes a first lens with positive refraction power, an aperture, a second lens with negative refraction power, a third lens with one of positive refraction power or negative refraction power, a fourth lens with positive refraction power, a fifth lens with negative refraction power, a filter, and an image sensor in the order from the object side to the image side. The camera lens is satisfied a following formula: 0.1<(0.5*p/D)<1.5, wherein D is a diameter of the aperture, p is a pixel size of the image sensor. The camera lens can image with high quality in low light by following the above formula.

### FIELD

The subject matter herein generally relates to a camera lens.

### BACKGROUND

In the field of photography, the camera lens is used to acquires visible light to capture the images. A camera lens may have an aperture to control the illuminance flux affecting the image quality. However, the camera lens may capture images with high quality in low light.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the disclosure. Implementations of the present technology will now be described, by way of example only, with reference to the attached figure.

FIG. 1 is a diagrammatic, cross sectional view of a first embodiment of a camera lens.

FIG. 2 is a graph respectively showing longitudinal spherical aberration of the first embodiment of the camera lens of FIG. 1.

FIG. 3 is a graph showing field curves of the first embodiment of the camera lens of FIG. 1.

FIG. 4 is a graph showing distortion of the first embodiment of the camera lens of FIG. 1.

FIG. 5 is a diagrammatic, cross sectional view of a second embodiment of a camera lens.

FIG. 6 is a graph showing longitudinal spherical aberration of the second embodiment of the camera lens of FIG. 5.

FIG. 7 is a graph showing field curves of the second embodiment of the camera lens of FIG. 5.

FIG. 8 is a graph showing distortion of the second embodiment of the camera lens of FIG. 5.

FIG. 9 is a diagrammatic, cross sectional view of a third embodiment of a camera lens.

FIG. 10 is a graph showing longitudinal spherical aberration of the third embodiment of the camera lens of FIG. 9.

FIG. 11 is a graph showing field curves of the third embodiment of the camera lens of FIG. 9.

FIG. 12 is a graph showing distortion of the third embodiment of the camera lens of FIG. 9.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

The present disclosure relates to a camera lens.

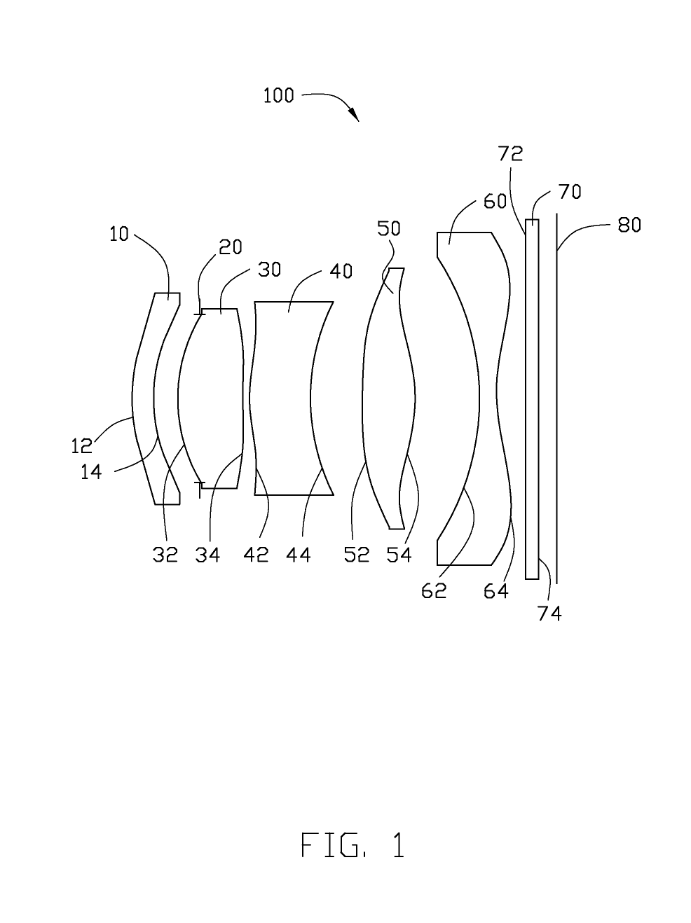

A first embodiment of a camera lens 100 is shown in FIG. 1, the camera lens 100 includes, in the order from an object side to an image side, a first lens 10 with positive refraction power, an aperture 20, a second lens 30 with negative refraction power, a third lens 40 that may have a positive refraction power or negative refraction power, a fourth lens 50 with positive refraction power, a fifth lens 60 with negative refraction power, a filter 70, and an image sensor 80.

The first lens 10 includes a first surface 12 and a second surface 14. The first surface 12 is a convex surface and faces the object side. The second surface 14 is opposite to the first surface 12 and is a concave surface.

The second lens 30 includes a third surface 32 and a fourth surface 34. The third surface 32 is a convex surface and faces the object side. The fourth surface 34 is opposite to the third surface 32.

The aperture 20 is used to control a amount of light reaching the second lens 30. In the first embodiment, the aperture 20 is positioned on the third surface 32 of the second lens 30.

The third lens 40 includes a fifth surface 42 and a sixth surface 44. The fifth surface 42 faces the object side. The sixth surface 44 is opposite to the fifth surface 42.

The fourth lens 50 includes a seventh surface 52 and an eighth surface 54. The seventh surface 52 is a convex surface and faces the object side. The eighth surface 54 is opposite to the seventh surface 52.

The fifth lens 60 includes a ninth surface 62 and a tenth surface 64. The ninth surface 62 is a concave surface and faces the object side. The tenth surface 64 is opposite to the ninth surface 62.

The filter 70 includes a front surface 72 and a rear surface 74, the filter 70 is positioned between the fifth lens 60 and the image sensor 80 and covers the image sensor 80.

The first surface 12, the second surface 14, the third surface 32, the fourth surface 34, the fifth surface 42, the sixth surface 44, the seventh surface 52, the eighth surface 54, the ninth surface 62, and the tenth surface 64 may be spherical surfaces or aspherical surfaces. In the first embodiment, the camera lens 100 satisfies the parameters of Tables 1-2. The symbols listed below are used in Tables 1 and Table 2.

R: a radius of curvature,

L: a distance between surfaces on the optical axis,

N: a refractive index of lens,

Vd: an Abbe number,

k: a conic constant.

TABLE 1

| | | | L | | | |
|---|---|---|---|---|---|---|
| surface | Type | R (mm) | (mm) | N | Vd | k |
| first surface | even aspherical | 2.48 | 0.34 | 1.64 | 23.3 | −3.01 |
| second surface | even aspherical | 1.97 | 0.77 | — | — | −0.22 |
| aperture | flat | Infinity | −0.36 | — | — | 0 |
| third surface | even aspherical | 2.49 | 1.05 | 1.54 | 56.1 | 0 |
| fourth surface | even aspherical | 5.33 | 0.13 | — | — | −159.27 |
| fifth surface | even aspherical | 2.62 | 0.98 | 1.64 | 23.3 | −17.57 |
| sixth surface | even aspherical | 2.69 | 0.85 | — | — | 0 |
| seventh surface | even aspherical | 11.25 | 0.86 | 1.54 | 56.1 | 0 |
| eighth surface | even aspherical | −2.62 | 1.05 | — | — | −5.87 |
| ninth surface | even aspherical | −6.16 | 0.27 | 1.54 | 55.6 | 0 |
| tenth surface | even aspherical | 2.98 | 0.48 | — | — | −9.81 |
| front surface | flat | Infinity | 0.21 | 1.52 | 58.6 | 0 |
| rear surface | flat | Infinity | 0.3 | — | — | 0 |
| image sensor | flat | Infinity | — | — | — | 0 |

TABLE 2

| | first lens | | second lens | | third lens | | fourth lens | | fifth lens | |
|---|---|---|---|---|---|---|---|---|---|---|
| aspherical | first | second | third | fourth | fifth | sixth | seventh | eighth | ninth | tenth |
| coefficient | surface | surface | surface | surface | surface | surface | surface | surface | surface | surface |
| A2 | 0 | 0 | 0 | 0 | 0 | 0 | 0 | 0 | 0 | 0 |
| A4 | −0.01045 | −0.04513 | −0.00757 | −0.07239 | −0.05131 | −0.03351 | 0.014637 | 0.004671 | −0.02121 | −0.02244 |
| A6 | −0.00314 | −0.00523 | 0.001296 | 0.022254 | 0.000526 | −0.00381 | −0.00051 | 0.005046 | 0.00442 | 0.003933 |
| A8 | −0.00056 | −0.00029 | −0.0034 | −0.00172 | 0.003543 | 0.004417 | −5.20E−05 | 0.000314 | −0.00025 | −0.00048 |
| A10 | 0.000846 | 0.001211 | 0.000551 | −0.00208 | 0.000344 | −0.00053 | 2.51E−05 | −0.00025 | −4.90E−05 | 9.80E−06 |
| A12 | −0.00013 | −0.00014 | 0.000159 | 0.000739 | −0.00016 | −5.10E−06 | −5.20E−06 | 1.89E−05 | 5.83E−06 | 9.09E−07 |
| A14 | 0 | 0 | 0 | 0 | 0 | 0 | 0 | 0 | 0 | 0 |
| A16 | 0 | 0 | 0 | 0 | 0 | 0 | 0 | 0 | 0 | 0 |

The even aspherical surfaces are shaped according to the formula:

$$Z = \frac{{ch}^{2}}{1 + \sqrt{1 - ( k + 1 ) {c}^{2} {h}^{2}}} + \sum {A}_{i} {h}^{i} \qquad ( 1 )$$

wherein Z is a displacement of the z-component from the aspherical surface to a vertex of the aspherical surface, h is a height from the optical axis of the lenses to the aspherical surface, c is a radius of curvature, k is a conic constant, and Ai are i-th order correction coefficients of the aspherical surfaces.

The camera lens 100 satisfies the formulas:

0.1<(0.5*p/D)<1.5; (2)

wherein D is a diameter of the aperture 20 in millimeters (mm), p is a pixel size of the image sensor 80 in micrometre (μm), the pixel size is a size of a photosensitive unit of the image sensor 80 and determines an amount of photons of light that the image sensor 80 can catch. In general, the diameter of the aperture 20 is increased, the amount of light can reach the image sensor 80 will be increased, and then the quality of images by the camera lens 100 is increased. The camera lens 100 can capture images with high quality in low light by following the formula (2).

The camera lens 100 further satisfies the formulas:

0.02<(t₂/f)<0.3; (3)

wherein t₂ is a center thickness of the second lens 30 in mm, f is a focal length of the camera lens 100 in mm. Formula (3) is used for decreasing the total thickness of the camera lens 100.

The camera lens 100 further satisfies the formulas:

0.4<Vd₁/Vd₂<3; (4)

wherein Vd₁ is an Abbe number of the first lens 10, Vd₂ is an Abbe number of the second lens 30. Preferably, the ratio of Vd₁ to Vd₂ satisfies the formulas:

0.8<Vd₁/Vd₂<3; (5)

Formula (4), and (5) is used for correcting the chromatic aberration of the images.

The camera lens 100 further satisfies the formulas:

0.2<R₁/f<0.9; (6)

wherein R₁ is a surface curvature of the first surface 12 of the first lens 10 in mm. Formula (6) is used for correcting the spherical aberration of the images and correcting the chromatic aberration of the images.

The camera lens 100 further satisfies the formulas:

1.5<f₃/f<5; (7)

wherein f₃ is a focal length of the third lens 40. Formula (7) is used for decreasing the spherical aberration of the images.

According to an example of the camera lens 100 of the first embodiment, wherein p=1.12, D=2.771, p/D=0.404, Vd₁=23.3, Vd₂=56.1, Vd₁/Vd₂=0.42, t₂=1.05, R₁=2.48, f₃=24.33, f=5.068, t₂/f=0.207, R₁/f=0.489, and f₃/f=4.800.

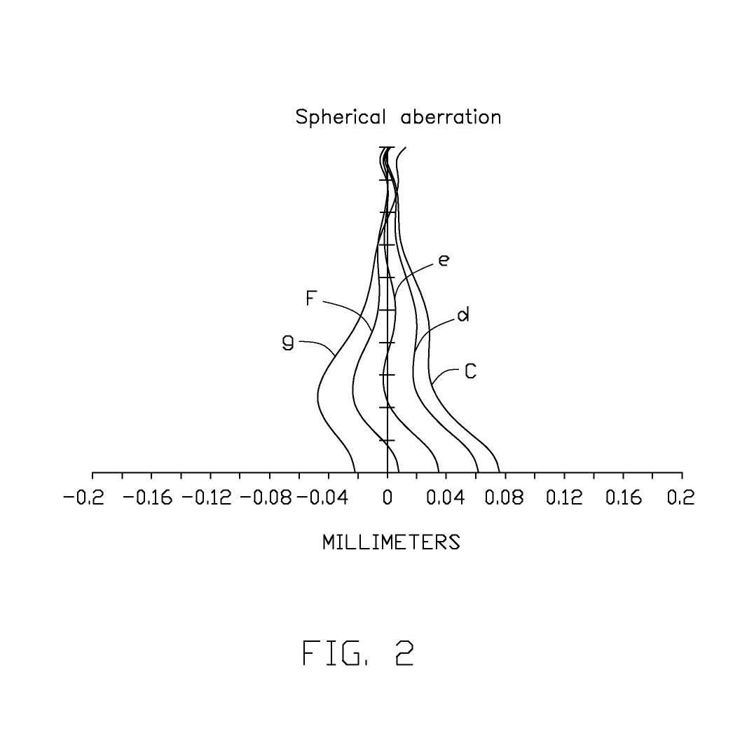

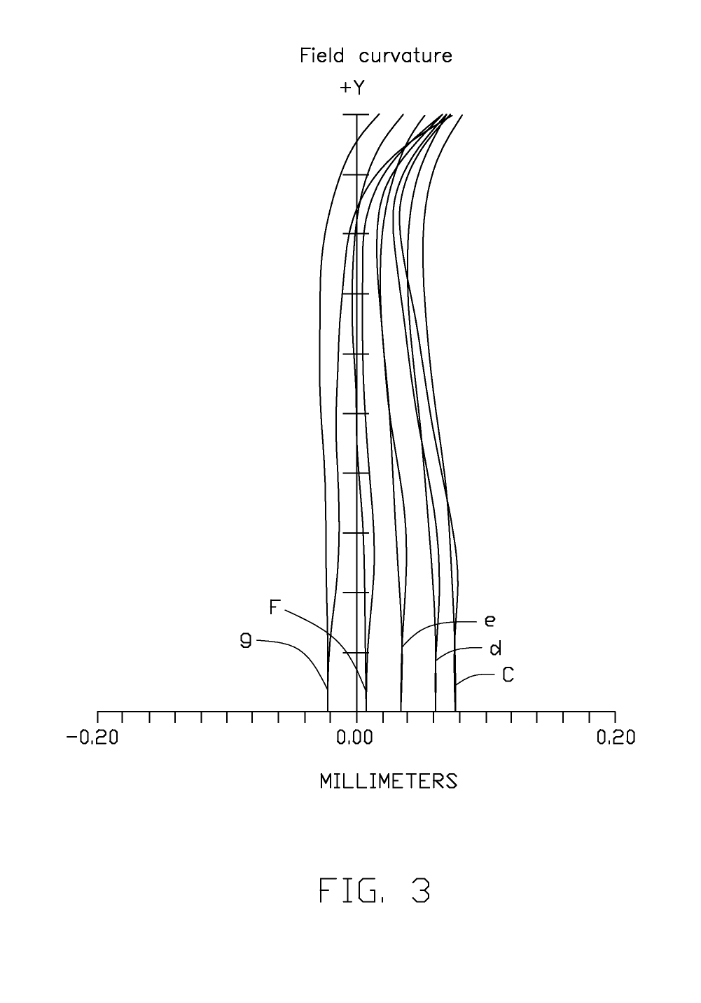

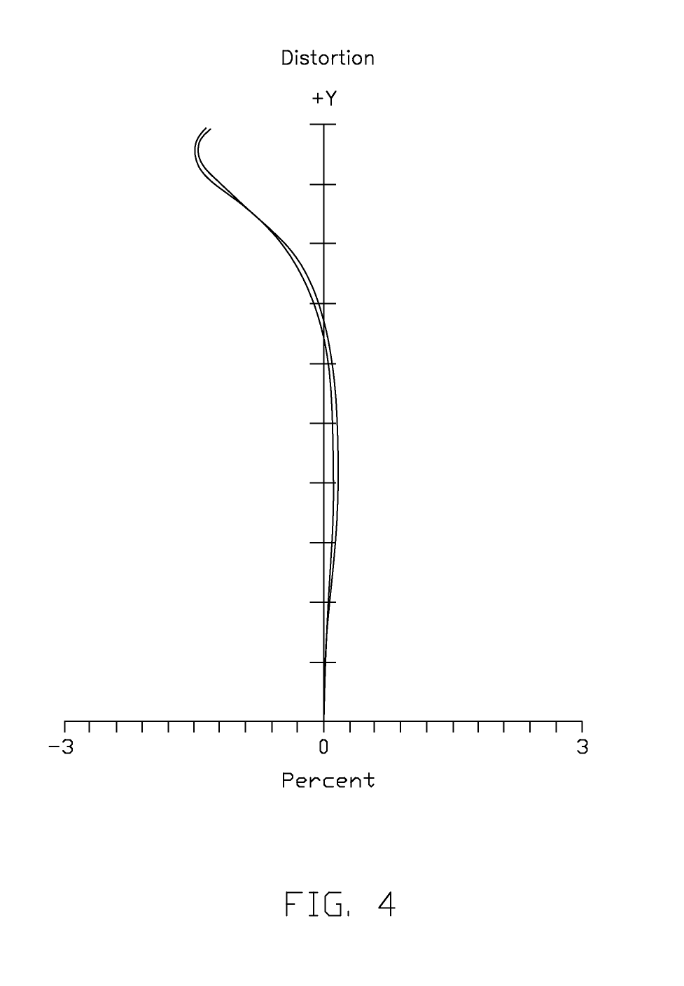

In the first embodiment, the spherical aberration graph, the field curvature graph, and the distortion graph of the camera lens 100 are respectively shown in FIGS. 2-4. The spherical aberration of visible light (with a wavelength between 400-700 nm) shown in FIG. 2 is within a range of −0.20 mm to 0.20 mm. The sagittal field curvature and the tangential field curvature shown in FIG. 3 are kept within a range of −0.20 mm to 0.20 mm. The distortion in FIG. 4 falls within a range of −3% to 3%. In the embodiment, the spherical aberration, field curvature, and distortion are well controlled in the camera lens 100.

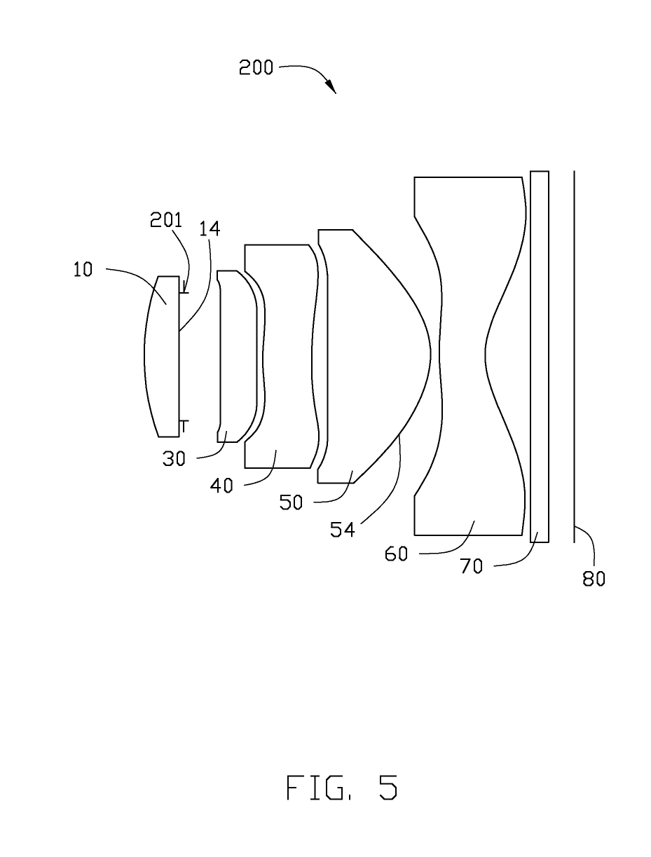

A second embodiment of a camera lens 200 is shown in FIG. 5. The camera lens 200 is similar to the camera lens 100 of the first embodiment of the present disclosure. The differences there between are that an aperture 201 is positioned on the second surface 14 of the first lens 10, and the eighth surface 54 is a convex surface.

In the second embodiment, the camera lens 200 satisfies the parameters of Tables 3-4 and the even aspherical surfaces of Tables 3-4 are shaped according to the formula (1). Listed below are the symbols used in Tables 3-4.

R: a radius of curvature,

L: a distance between surfaces on the optical axis,

N: a refractive index of lens,

Vd: an Abbe number,

k: a conic constant.

TABLE 3

| | | | L | | | |
|---|---|---|---|---|---|---|
| surface | Type | R (mm) | (mm) | N | Vd | k |
| first surface | even aspherical | 2.32 | 0.4 | 1.64 | 23.3 | −1.47 |
| second surface | even aspherical | 13.82 | 0.06 | | | 0 |
| aperture | flat | Infinity | 0.43 | | | 0 |
| third surface | even aspherical | 28.83 | 0.42 | 1.54 | 56.1 | 0 |
| fourth surface | even aspherical | 3.77 | 0.08 | | | −193.95 |
| fifth surface | even aspherical | 2.61 | 0.57 | 1.64 | 23.3 | −38.75 |
| sixth surface | even aspherical | 3.23 | 0.21 | | | 0 |
| seventh surface | even aspherical | −15.77 | 1.19 | 1.54 | 56.1 | 106.84 |
| eighth surface | even aspherical | −0.85 | 0.11 | | | −3.37 |
| ninth surface | even aspherical | 6.25 | 0.53 | 1.54 | 55.6 | 0 |
| tenth surface | even aspherical | 0.77 | 0.53 | | | −4.4 |
| front surface | flat | Infinity | 0.21 | 1.52 | 58.6 | 0 |
| rear surface | flat | Infinity | 0.3 | | | 0 |
| image sensor | flat | Infinity | — | | | 0 |

TABLE 4

| | first lens | | second lens | | third lens | | fourth lens | | fifth lens | |
|---|---|---|---|---|---|---|---|---|---|---|
| aspherical | first | second | third | fourth | fifth | sixth | seventh | eighth | ninth | tenth |
| coefficient | surface | surface | surface | surface | surface | surface | surface | surface | surface | surface |
| A2 | 0 | 0 | 0 | 0 | 0 | 0 | 0 | 0 | 0 | 0 |
| A4 | −0.01378 | −0.04507 | −0.08464 | −0.2016 | −0.22487 | −0.07697 | 0.018659 | −0.09248 | −0.12587 | −0.05491 |
| A6 | 0.022297 | 0.019316 | 0.14529 | −0.13066 | −0.06231 | −0.01071 | −0.0497 | −0.00078 | 0.016394 | 0.015457 |
| A8 | −0.08014 | −0.09364 | −0.30656 | 0.155272 | −0.10597 | 0.023908 | 0.103059 | 0.023161 | 0.00513 | −0.00317 |
| A10 | 0.061684 | 0.083042 | 0.303046 | −0.11963 | 0.062848 | −0.03179 | −0.09095 | −0.0122 | −0.00135 | 0.000385 |
| A12 | −0.03206 | −0.03817 | −0.1565 | 0.023435 | 0.01868 | 0.009671 | 0.023599 | 0.002698 | −2.40E−05 | −2.70E−05 |
| A14 | 0 | 0 | 0 | 0 | 0 | 0 | 0 | 0 | 0 | 0 |
| A16 | 0 | 0 | 0 | 0 | 0 | 0 | 0 | 0 | 0 | 0 |

The camera lens 200 further satisfies the formulas:

0.1<(0.5*p/D)<1.5; (2)

0.02<(t₂/f)<0.3; (3)

0.4<Vd₁/Vd₂<3; (4)

0.2<R₁/f<0.9; (6)

1.5<f₃/f<5; (7)

wherein D is a diameter of the aperture 201 in mm, p is a pixel size of the image sensor 80 in μm, t₂ is a center thickness of the second lens 30 in mm, f is a focal length of the camera lens 200 in mm, Vd₁ is an Abbe number of the first lens 10, Vd₂ is an Abbe number of the second lens 30, R₁ is a surface curvature of the first surface 12 of the first lens 10 in mm, f₃ is a focal length of the third lens 40 in mm.

According to an example of the camera lens 200 of the second embodiment, wherein p=2.24, D=1.507, p/D=1.486, Vd₁=23.3, Vd₂=56.1, Vd₁/Vd₂=0.42, t₂=0.42, R₁=2.32, f₃=15.615, f=3.252, t₂/f=0.129, R₁/f=0.714, and f₃/f=4.802.

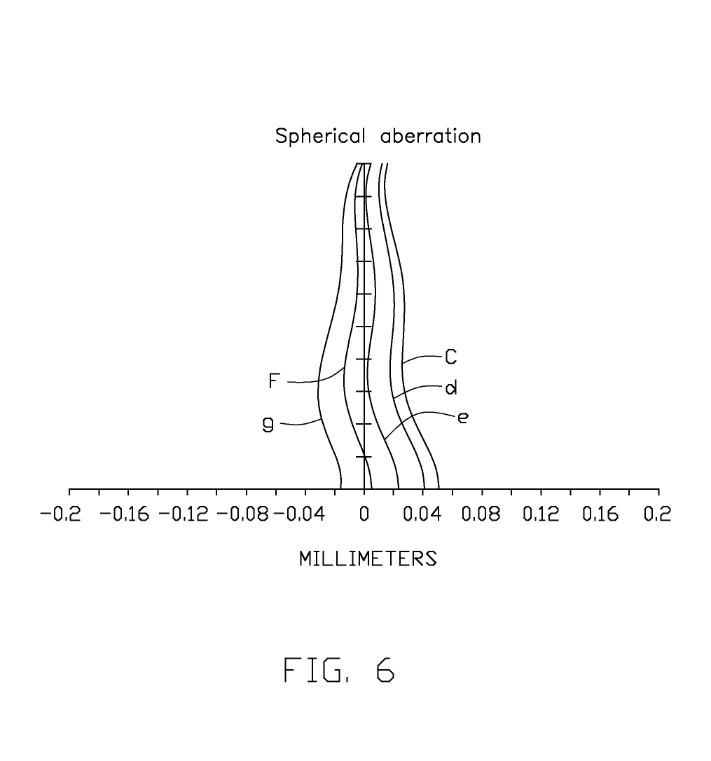

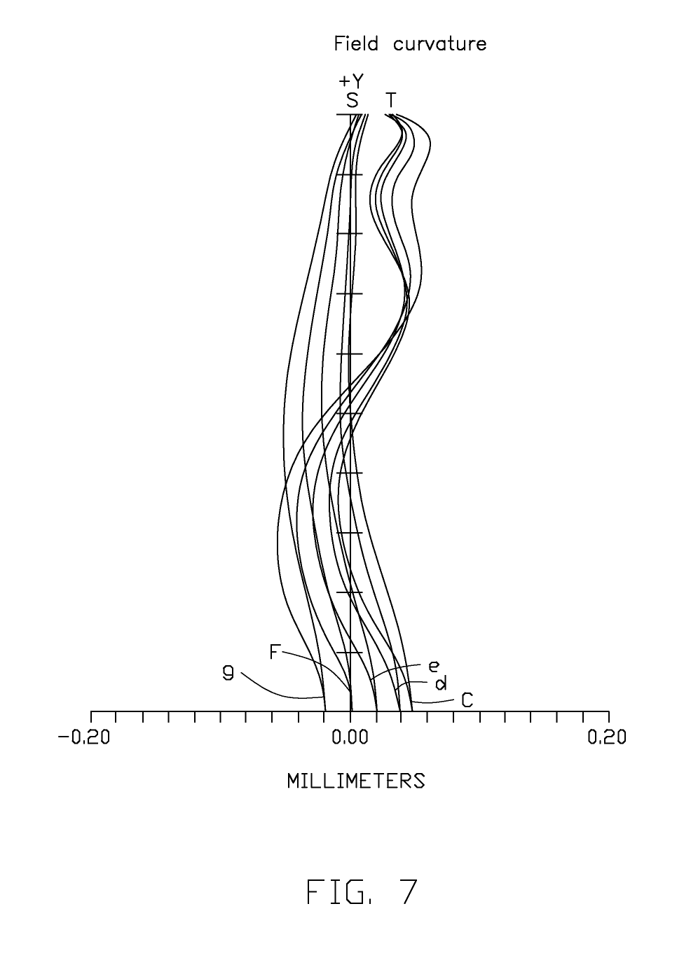

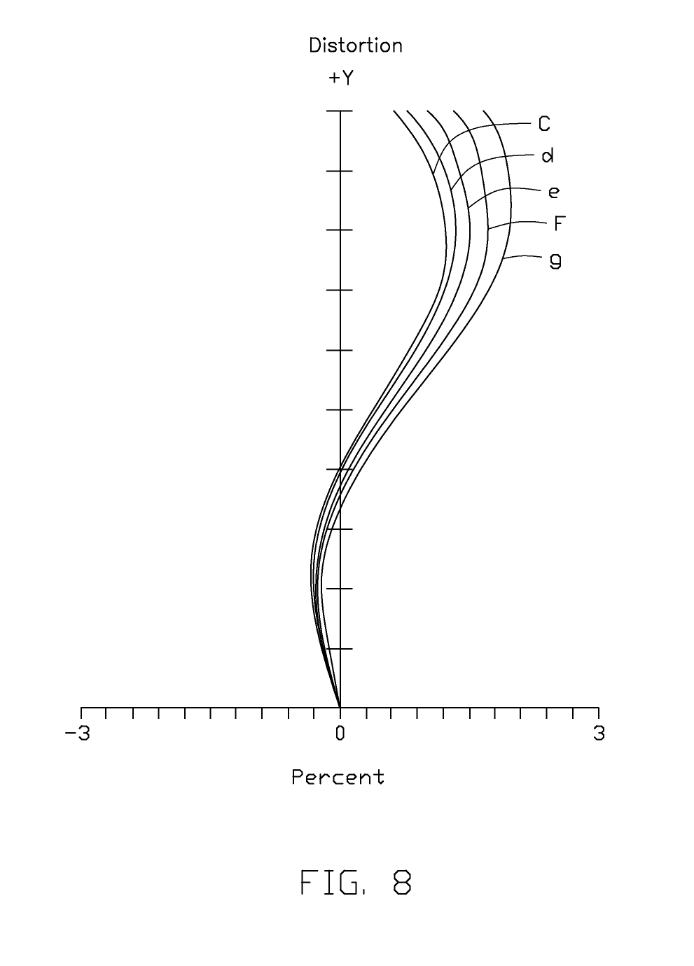

In the second embodiment, the spherical aberration graph, the field curvature graph, and the distortion graph of the camera lens 100 are respectively shown in FIGS. 6-8. The spherical aberration of visible light (with a wavelength between 400-700 nm) shown in FIG. 6 is within a range of −0.20 mm to 0.20 mm. The sagittal field curvature and the tangential field curvature shown in FIG. 7 are kept within a range of −0.20 mm to 0.20 mm. The distortion in FIG. 8 falls within a range of −3% to 3%. Obviously, the spherical aberration, field curvature, and distortion are well controlled in the camera lens 200.

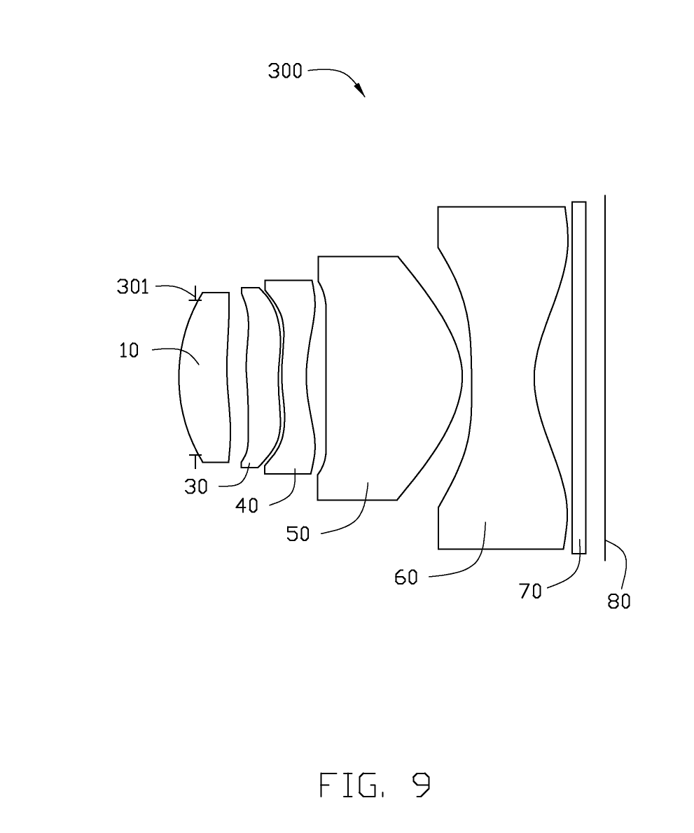

A third embodiment of a camera lens 300 is shown in FIG. 9, the camera lens 100 includes, in the order from an object side to an image side, an aperture 301, a first lens 10 with positive refraction power, a second lens 30 with negative refraction power, a third lens 40 with one of positive refraction power or negative refraction power, a fourth lens 50 with positive refraction power, a fifth lens 60 with negative refraction power, a filter 70, and an image sensor 80.

In the third embodiment, the camera lens 300 satisfies the parameters of Tables 5-6 and the even aspherical surfaces of Tables 5-6 are shaped according to the formula (1). The symbols listed below are used in Tables 5-6.

R: a radius of curvature,

L: a distance between surfaces on the optical axis,

N: a refractive index of lens,

Vd: an Abbe number,

k: a conic constant.

TABLE 5

| | | | L | | | |
|---|---|---|---|---|---|---|
| surface | Type | R (mm) | (mm) | N | Vd | k |
| aperture | flat | Infinity | −0.25 | | | |
| first surface | even aspherical | 2.43 | 0.73 | 1.54 | 56.1 | −1.06 |
| second surface | even aspherical | 7.01 | 0.29 | | | 0 |
| third surface | even aspherical | 5.79 | 0.48 | 1.54 | 56.1 | 0 |
| fourth surface | even aspherical | 2.69 | 0.05 | | | −60.46 |
| fifth surface | even aspherical | 2.47 | 0.38 | 1.64 | 23.3 | −31.28 |
| sixth surface | even aspherical | 2.84 | 0.28 | | | 0 |
| seventh surface | even aspherical | 17.29 | 2.07 | 1.54 | 56.1 | 0 |
| eighth surface | even aspherical | −1.27 | 0.16 | | | −3.17 |
| ninth surface | even aspherical | −9.96 | 0.92 | 1.54 | 55.6 | 0 |
| tenth surface | even aspherical | 1.34 | 0.57 | | | −5.57 |
| front surface | flat | Infinity | 0.21 | 1.52 | 58.6 | 0 |
| rear surface | flat | Infinity | 0.3 | | | 0 |
| image sensor | flat | Infinity | — | | | 0 |

TABLE 6

| | first lens | | second lens | | third lens | | fourth lens | | fifth lens | |
|---|---|---|---|---|---|---|---|---|---|---|
| aspherical | first | second | third | fourth | fifth | sixth | seventh | eighth | ninth | tenth |
| coefficient | surface | surface | surface | surface | surface | surface | surface | surface | surface | surface |
| A2 | 0 | 0 | 0 | 0 | 0 | 0 | 0 | 0 | 0 | 0 |
| A4 | 0.003673 | −0.03892 | −0.09296 | −0.13369 | −0.13285 | −0.0578 | 0.006051 | −0.02293 | −0.03601 | −0.02217 |
| A6 | 0.014789 | 0.022524 | 0.066631 | 0.012628 | 0.004881 | −0.01121 | −0.0183 | −0.00233 | 0.00439 | 0.004373 |
| A8 | −0.01705 | −0.01869 | −0.06607 | 0.011563 | −0.01266 | 0.005246 | 0.015574 | 0.004531 | −7.60E−05 | −0.00057 |
| A10 | 0.010798 | 0.010217 | 0.041076 | −0.01102 | 0.00624 | −0.00385 | −0.01307 | −0.00171 | 5.49E−06 | 2.98E−05 |
| A12 | −0.00281 | −0.00329 | −0.01242 | 0.002085 | 0.000421 | 0.001155 | 0.002848 | 0.000246 | 1.65E−06 | −4.80E−07 |
| A14 | 0 | 0 | 0 | 0 | 0 | 0 | 0 | 0 | 0 | 0 |
| A16 | 0 | 0 | 0 | 0 | 0 | 0 | 0 | 0 | 0 | 0 |

The camera lens 300 further satisfies the formulas:

0.1<(0.5*p/D)<1.5; (2)

0.02<(t₂/f)<0.3; (3)

0.8<Vd₁/Vd₂<3; (5)

0.2<R₁/f<0.9; (6)

1.5<f₃/f<5; (7)

wherein D is a diameter of the aperture 301 in mm, p is a pixel size of the image sensor 80 in μm, t₂ is a center thickness of the second lens 30 in mm, f is a focal length of the camera lens 300, Vd₁ is an Abbe number of the first lens 10, Vd₂ is an Abbe number of the second lens 30, R₁ is a surface curvature of the first surface 12 of the first lens 10 in mm, f₃ is a focal length of the third lens 40.

According to an example of the camera lens 300 of the third embodiment, wherein p=1.4, D=2.413, p/D=1.723, Vd₁=56.1, Vd₂=56.1, Vd₁/Vd₂=1, t₂=0.48, R₁=2.43, f₃=20.863, f=4.343, t₂/f=0.111, R₁/f=0.559, and f₃/f=4.804.

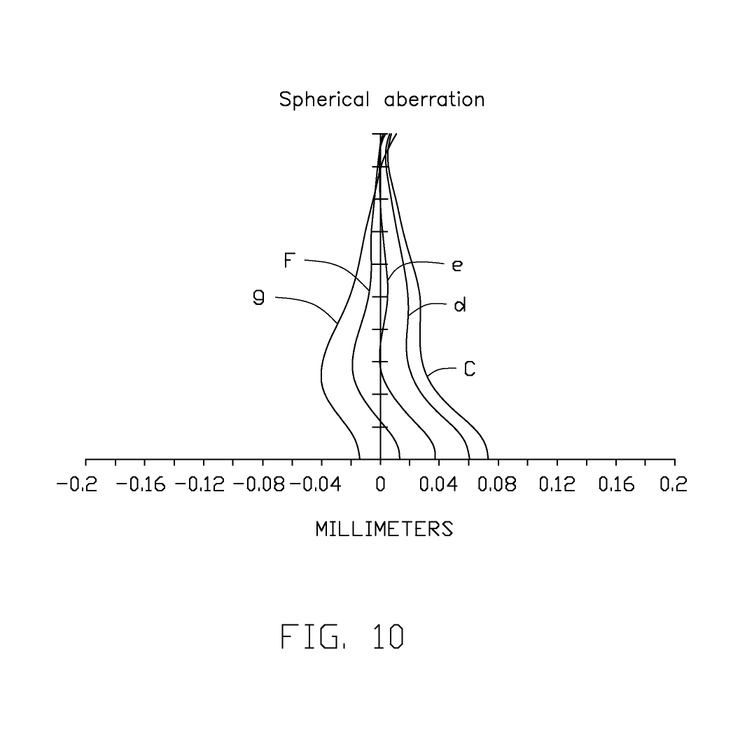

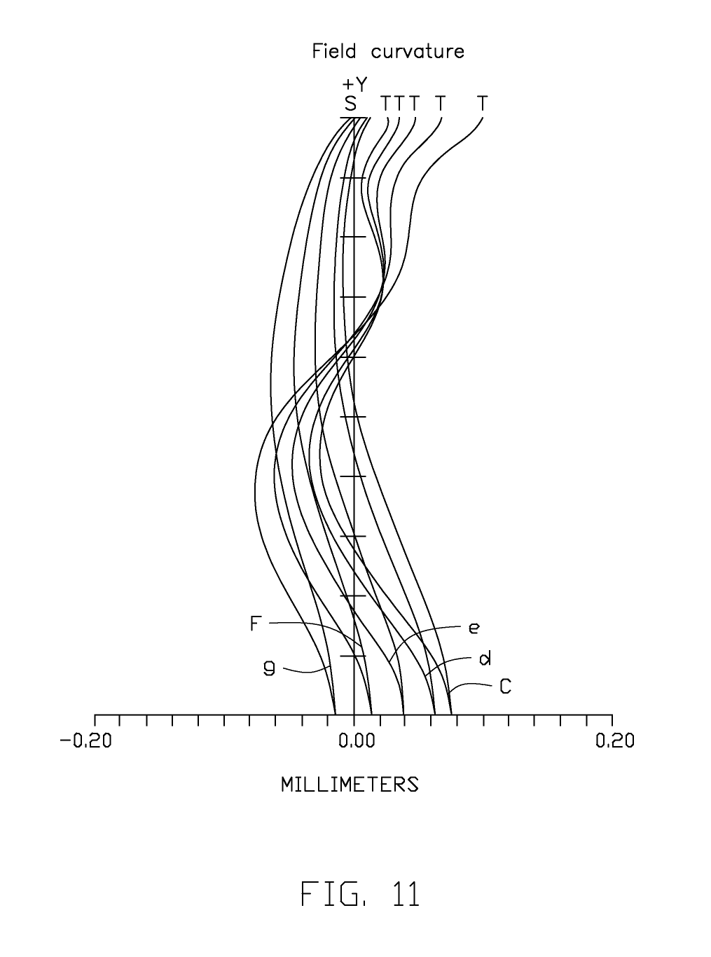

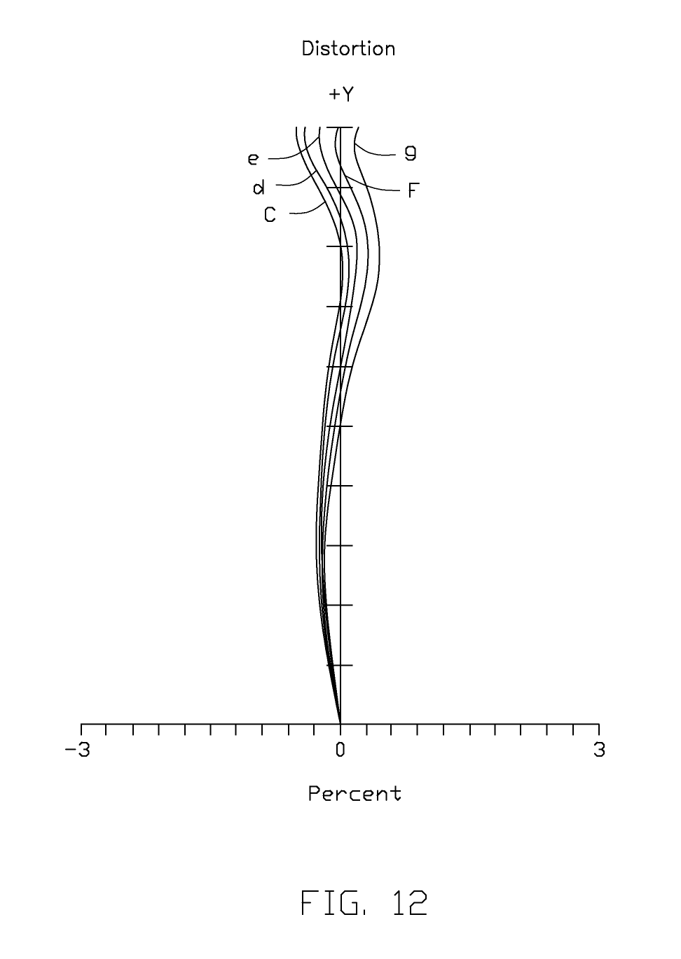

In the third embodiment, the spherical aberration graph, the field curvature graph, and the distortion graph of the camera lens 300 are respectively shown in FIGS. 10-12. The spherical aberration of visible light (with a wavelength between 400-700 nm) shown in FIG. 10 is within a range of −0.20 mm to 0.20 mm. The sagittal field curvature and the tangential field curvature shown in FIG. 11 are kept within a range of −0.20 mm to 0.20 mm. The distortion in FIG. 12 falls within a range of −3% to 3%. Obviously, the spherical aberration, field curvature, and distortion are well controlled in the camera lens 300.

Wherein the wavelength of g, F, e, d, and C lights of FIGS. 2-4, FIGS. 6-8, and FIGS. 10-12 are 435.8 nm, 486.1 nm, 546.1 nm, 588 nm, and 656.3 nm respectively.

The embodiments shown and described above are only examples. Many details are often found in the art such as the other features of a camera lens. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A camera lens, in the order from the object side to the image side, the camera lens comprising:
a first lens with positive refraction power;
an aperture;
a second lens with negative refraction power;
a third lens with one of positive refraction power or negative refraction power;
a fourth lens with positive refraction power;
a fifth lens with negative refraction power; and
an image sensor;
wherein the camera lens is satisfied a following formula:
0.1<(0.5*p/D)<1.5,
where D is a diameter of the aperture in mm, p is a pixel size of the image sensor in μm.

2. The camera lens in accordance with claim 1, wherein the first lens includes a first surface positioned closer to the object and a second surface opposite to the first surface, the first surface is a convex surface, the aperture is positioned on the second surface.

3. The camera lens in accordance with claim 1, wherein the second lens includes a third surface positioned closer to the object and a fourth surface opposite to the third surface, the aperture is positioned on the third surface.

4. The camera lens in accordance with claim 1, wherein the camera lens is satisfied a following formula:
0.02<(t₂/f)<0.3,
where t₂ is a center thickness of the second lens in mm, f is a focal length of the camera lens in mm.

5. The camera lens in accordance with claim 4, wherein the camera lens is satisfied a following formula:
0.8<(Vd₁/Vd₂)<3,
where Vd₁ is an Abbe number of the first lens, Vd₂ is an Abbe number of the second lens.

6. The camera lens in accordance with claim 5, wherein the camera lens is satisfied a following formula:
0.2<(R₁/f)<3,
where R₁ is a surface curvature of a first surface of the first lens in mm, f is a focal length of the camera lens in mm.

7. The camera lens in accordance with claim 6, wherein the camera lens is satisfied a following formula:
1.5<(f₃/f)<5,
where f₃ is a focal length of the third lens in mm, f is a focal length of the camera lens in mm.

8. A camera lens, in the order from the object side to the image side, the camera lens comprising:
an aperture;
a first lens with positive refraction power;
a second lens with negative refraction power;
a third lens with one of positive refraction power or negative refraction power;
a fourth lens with positive refraction power;
a fifth lens with negative refraction power; and
an image sensor;
wherein the camera lens is satisfied a following formula:
0.1<(0.5*p/D)<1.5,
where D is a diameter of the aperture in mm, p is a pixel size of the image sensor in μm.

9. The camera lens in accordance with claim 8, wherein the camera lens is satisfied a following formula:
0.02<(t₂/f)<0.3, and
0.8<(Vd₁/Vd₂)<3,
where t₂ is a center thickness of the second lens in mm, f is a focal length of the camera lens in mm, Vd₁ is an Abbe number of the first lens, Vd₂ is an Abbe number of the second lens.

10. The camera lens in accordance with claim 9, wherein the camera lens is satisfied a following formula:
0.2<(R₁/f)<0.9, and
1.5<(f₃/f)<5,
where R₁ is a surface curvature of a first surface of the first lens in mm, f₃ is a focal length of the third lens in mm, f is a focal length of the camera lens in mm.

11. A camera lens, in order from an object side to an image side, the camera lens comprising:
a first lens with positive refraction power;
an aperture;
a second lens with negative refraction power;
a third lens having a convex object side surface;
a fourth lens with positive refraction power;
a fifth lens with negative refraction power; and
an image sensor;
wherein the camera lens is satisfied a following formula:
0.1<(0.5*p/D)<1.5,
where D is a diameter of the aperture in mm, and p is a pixel size of the image sensor in μm.
